(19) United States
(12) Patent Application Publication
(10) Pub. No.: US 2019/0282031 A1
(43) Pub. Date: Sep. 19, 2019

(54) Ceramic Oven and Installation Method of Insert on Oven Body thereof

(71) Applicant: Fudu Feng, Nantong (CN)

(72) Inventor: Fudu Feng, Nantong (CN)

(21) Appl. No.: 15/928,118

(22) Filed: Mar. 22, 2018

(30) Foreign Application Priority Data
Mar. 13, 2018 (CN) 201810204701.5

(51) Int. Cl. A47J 37/07

(52) U.S. Cl. CPC A47J 37/0763; A47J 37/0786

(57) ABSTRACT

The disclosure claims a ceramic oven and an installation method of an insert on an oven body thereof. The ceramic oven mainly comprises an oven body (1), a base and an insert, wherein the oven body (1) is placed on the base, an oven cover (5) is arranged at the top of the oven body (1) and a cover cap (7) is arranged on the oven cover (5), placing tables (6) are installed on the left and right sides of the oven body (1) through bolts, more than one hole (2) is formed on the side wall or at the bottom of the oven body (1), a track (3) is paved in the hole (2), and a limiting baffle plate (4) is arranged at the top of the track (3); and the insert is inserted on the track (3) of the hole (2). The method comprises the following steps: forming the hole for the oven body-paving the track-inserting the “Insert”-processing the “Insert”. The ceramic oven has characteristics of diversified energy use, good taste of baked food and convenient use.

### BACKGROUND OF THE INVENTION

### 1. Field of the Invention

The disclosure relates to a technical field of a barbecue utensil, and more particularly to a ceramic oven and an installation method of an insert on an oven body thereof.

### 2. Description of the Related Art

Traditional ovens have a wide variety and various styles, but most of ovens are mainly made of metal materials, and the baked food has an extremely poor taste. Besides, energy used by the traditional ovens is also relatively single, a charcoal-burning oven only makes charcoal, an electric oven only uses power, and a liquefied gas oven only uses liquefied gas. No oven has diversified selection of the energy, therefore, the energy used by the oven is very limited. Especially, it is also very troublesome for the charcoal-burning oven when processing charcoal ash.

Therefore, a ceramic oven and an installation method of an insert on an oven body thereof are urgently needed to solve the above problem.

### SUMMARY OF THE INVENTION

To solve the problem, the disclosure claims a ceramic oven and an installation method of an insert on an oven body thereof. The ceramic oven has characteristics of good taste of baked food, diversified selection for energy use, and convenient use. A ceramic oven and an installation method of an insert on an oven body thereof, wherein the ceramic oven mainly comprises an oven body (1), a base and an insert, wherein the oven body (1) is placed on the base, an oven cover (5) is arranged at the top of the oven body (1) and a cover cap (7) is arranged on the oven cover (5), placing tables (6) are installed on the left and right sides of the oven body (1) through bolts, more than one hole (2) is formed on the side wall or at the bottom of the oven body (1), a track (3) is paved in the hole (2), and a limiting baffle plate (4) is arranged at the top of the track (3); and the insert is inserted on the track (3) of the hole (2).

The ceramic oven and the installation method of the insert on the oven body thereof, wherein the method comprises the following steps: forming the hole for the oven body, paving the track, inserting the “Insert”, processing the “Insert”:

Step I, forming the hole for the oven body: after a ceramic oven body is molded, the hole (2) for inserting the “Insert” is preformed on the side wall of the body thereof, and size and shape of the hole are matched with the “Insert” to be inserted;

Step II, paving the track: the track (3) for facilitating access of the “Insert” is paved in the preformed hole (2) of the “Insert”, and a fixing device of the limiting baffle plate (4) and the “Insert” is arranged on the track (3);

Step III, inserting the “Insert”: an inserting end of the “Insert” is placed on the track (3) of the hole (2) of the “Insert”, and the “Insert” is pushed into the ceramic oven body;

Step IV, processing the “Insert”: when the “Insert” is a particle charcoal placing box or an ash pit box, the ash pit is taken out after being filled with charcoal ash, the charcoal ash is poured into a garbage can, and the “Insert” is inserted into the ceramic oven body; when the “Insert” is a gas box or an electromagnetic box, the insert is not often taken out; and when the “Insert” is a baking tray or a spice box, the insert is taken out after food in the baking tray is baked completely.

Further, the insert of the disclosure is the particle charcoal placing box or the gas box or the electromagnetic box or the ash pit box or the baking tray or the spice box.

Further, when the number of the hole (2) of the disclosure is one, the hole (2) is arranged on the front side wall or the rear side wall or the left side wall or the right side wall of the oven body (1) or at the bottom of the oven body (1); and when the number of the hole (2) is two, the hole (2) is arranged on the same side wall or different side walls of the oven body (1).

Further, the insert (the English name is Insert) in the disclosure is a functional box designed for the ceramic oven.

Further, originally, the insert in the disclosure is designed for removing the charcoal ash in the ceramic oven effectively and rapidly.

Further, the insert in the disclosure creates different function extensions according to a usage method, and can be divided into the following ones:

1) Particle box, also called Pellet Insert: the insert is used by the ceramic oven by transferring wood chips as fuel;

2) Gas box, also called Gas Insert: the insert is used by the ceramic oven by connecting liquefied petroleum gas as fuel;

3) Electromagnetic box, also called Electric Insert: the insert is used by the ceramic box with fuel of powering on;

4) Multi-function box, also called Multi-Insert: it can be used as the baking tray or the spice box.

5) Ash pit box, also called Ash Drawer: when charcoal fuel is used by the ceramic oven and the charcoal ash generated is fallen from the oven, the charcoal ash is caught by the ash pit box, and when the ash pit is filled with the charcoal ash, the ash pit is taken out to pour the charcoal ash into the garbage can.

Further, the disclosure is a combination or assembly way of the “oven body” and the “Insert” and a selectivity that the “Insert” is easy to replace.

The insert has the following assembly ways:

1. A single insert may be installed at either side of the ceramic oven body, such as: the front side, the rear side, the left side or the right side; and a height that the insert is installed at one side of the ceramic oven body is not limited.

2. When two inserts are simultaneously arranged on the ceramic oven body, one may be configured to catch the charcoal ash, and the other may be used as the baking tray or the spice box. The insert for catching the charcoal ash and the insert as the baking tray can be simultaneously arranged at one side of the ceramic oven body, and can also be arranged at the different sides of the ceramic oven body.

3. Shapes, sizes and materials of the ceramic oven body and the insert are not limited, as long as the installation of the two is matched.

Further, due to difference of the fuel used in the disclosure, the “Insert” with a use purpose of different fuels can be replaced at any time, thereby adding a diversified selection of the ceramic oven in the different fuels or different environments.

The disclosure has beneficial effects that:

The ceramic oven has characteristics of diversified energy use, good taste of baked food and convenient use.

A series of concepts with simplified forms is introduced in the summary of the disclosure, which is further elaborated in a specific embodiment. The summary of the disclosure does not mean trying to define key features and necessary technical features of the claimed technical solution, and even, does not mean trying to determine the protection scope of the claimed technical solution.

The advantages and features of the disclosure are elaborated in combination with the following description.

### BRIEF DESCRIPTION OF THE DRAWINGS

FIG. 1 is a schematic diagram of a hole formed on the main view surface of an oven body according to the disclosure;

FIG. 2 is a schematic diagram of two holes formed on the main view surface of an oven body according to the disclosure;

FIG. 3 is a schematic diagram of a hole formed on the rear view surface of an oven body according to the disclosure;

FIG. 4 is a schematic diagram of two holes formed on the rear view surface of an oven body according to the disclosure;

FIG. 5 is a schematic diagram of a hole formed on the right side of an oven body according to the disclosure;

FIG. 6 is a schematic diagram of two holes formed on the right side of an oven body according to the disclosure;

FIG. 7 is a schematic diagram of a hole formed on the left side of an oven body according to the disclosure;

FIG. 8 is a schematic diagram of two holes formed on the left side of an oven body according to the disclosure;

FIG. 9-FIG. 12 are schematic diagrams of holes formed on the different sides of an oven body simultaneously according to the disclosure;

FIG. 13 is a schematic diagram of a hole formed at the bottom of an oven body according to the disclosure;

FIG. 14-FIG. 16 are schematic diagrams of holes formed at the bottom and on the sides of an oven body simultaneously according to the disclosure;

FIG. 17 is a schematic diagram for internal amplification of a hole according to the disclosure;

FIG. 18-FIG. 19 are schematic diagrams of an “Insert” according to the disclosure.

In the Figure, 1. Oven body 2. Hole 3. Track 4. Limiting baffle plate 5. Oven cover 6. Placing tables 7. Cover cap

### DETAILED DESCRIPTION OF THE PREFERRED EMBODIMENTS

In the following description, a lot of specific details are given to provide more thorough understanding for the disclosure. However, it is apparent for those skilled in the art, and the disclosure can be implemented without one or more details. In other examples, some technical features known in the art are not described, so as to avoid mixing with the disclosure.

To understand the disclosure thoroughly, a detailed structure is proposed in description below. Apparently, the implementation of the disclosure is not limited to special details familiarized by those skilled in the art. Better embodiments of the disclosure are elaborated below, and however, in addition to the detailed description, the disclosure further has other embodiments.

Detailed description is made below to embodiments of the disclosure.

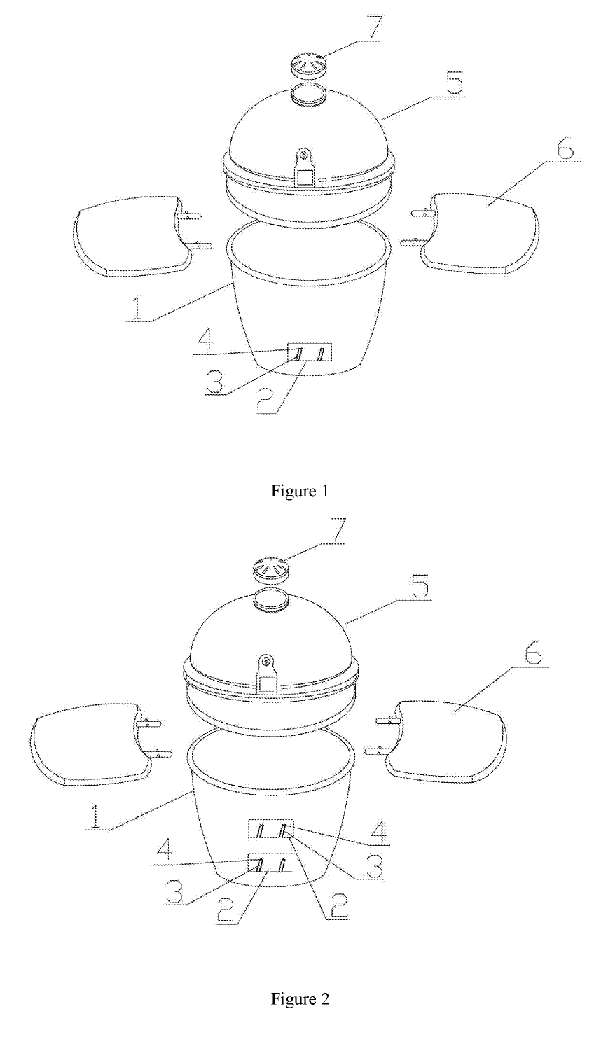

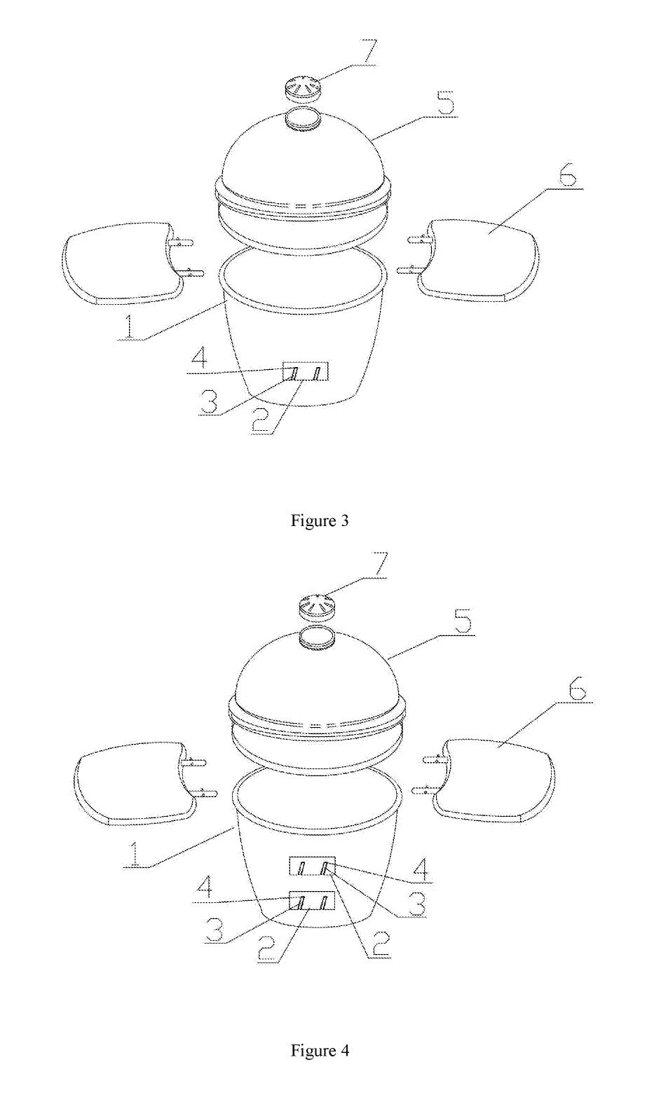

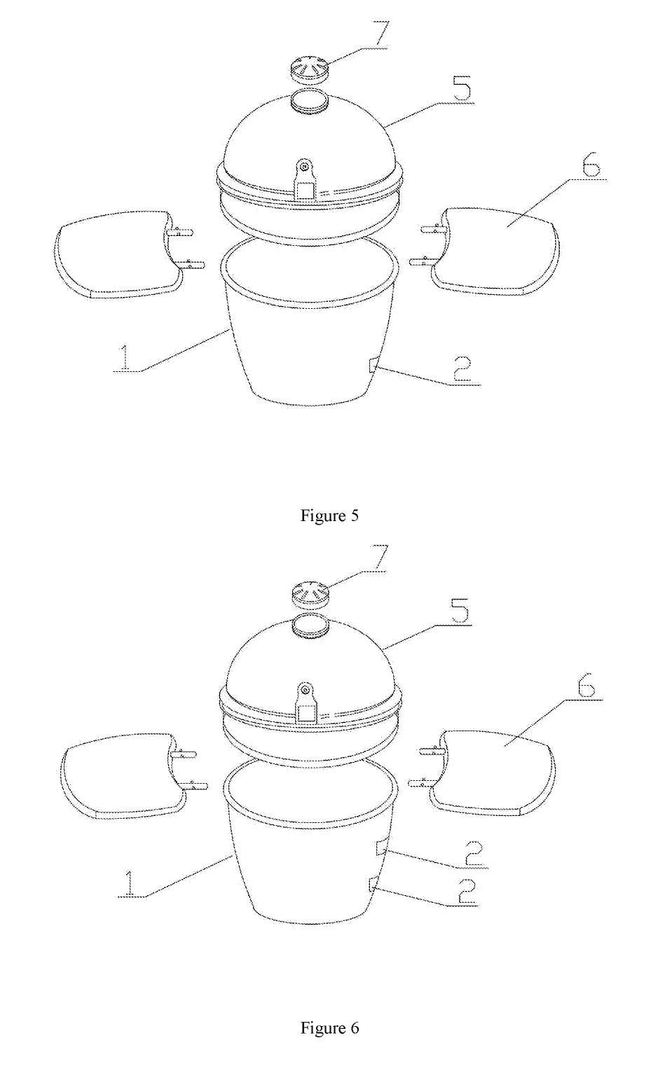

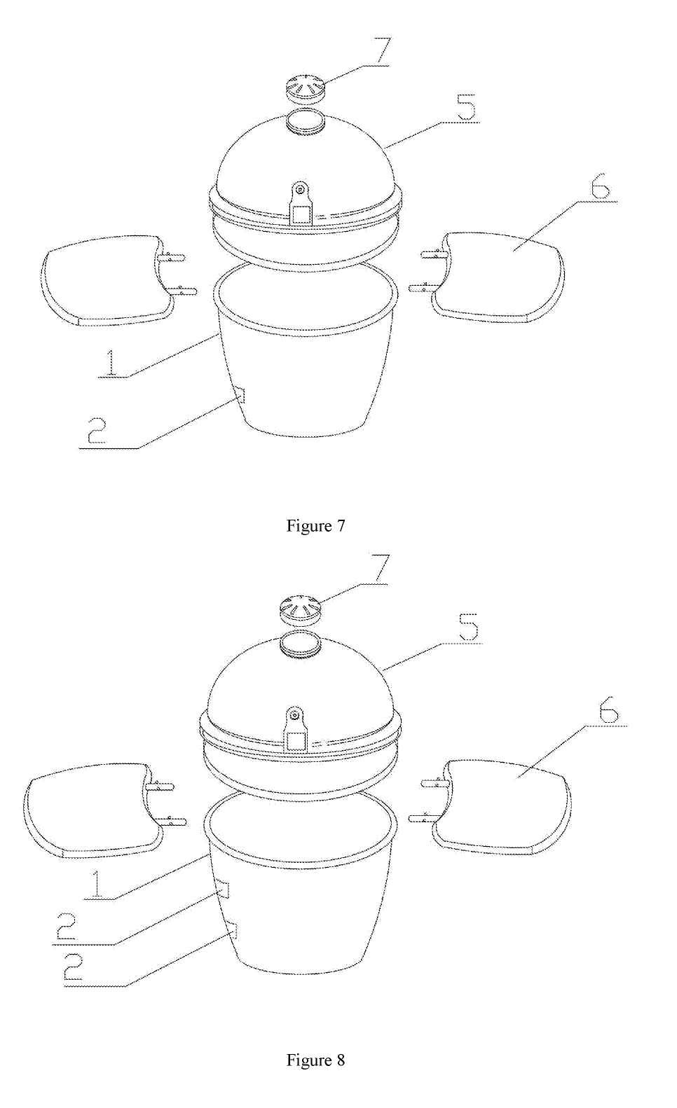

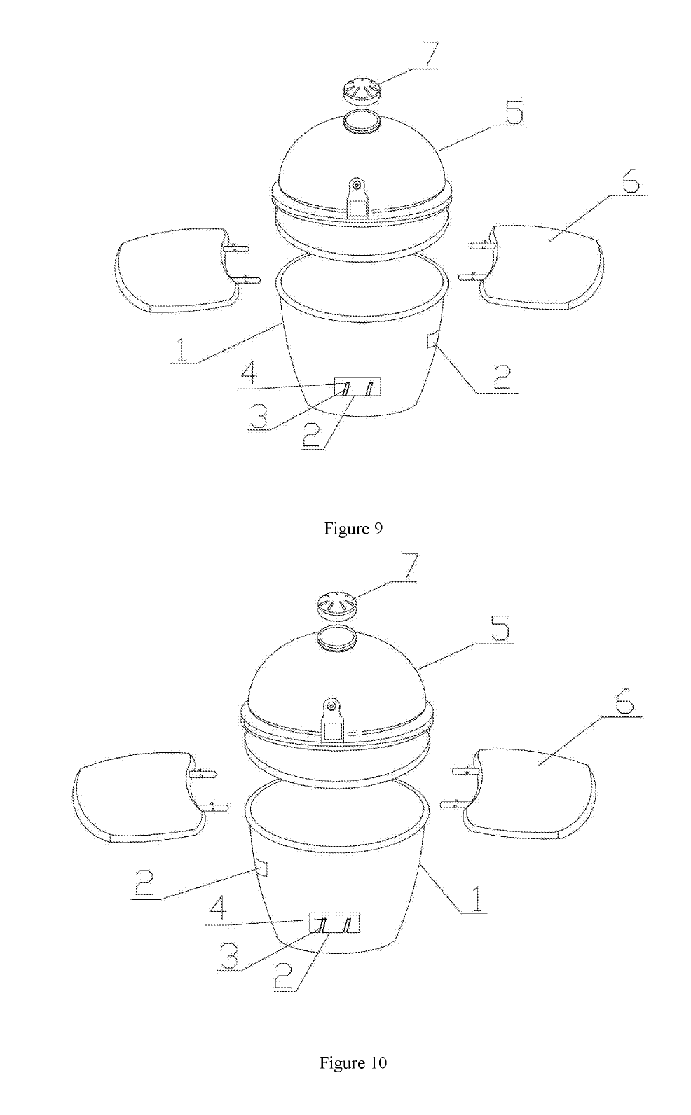

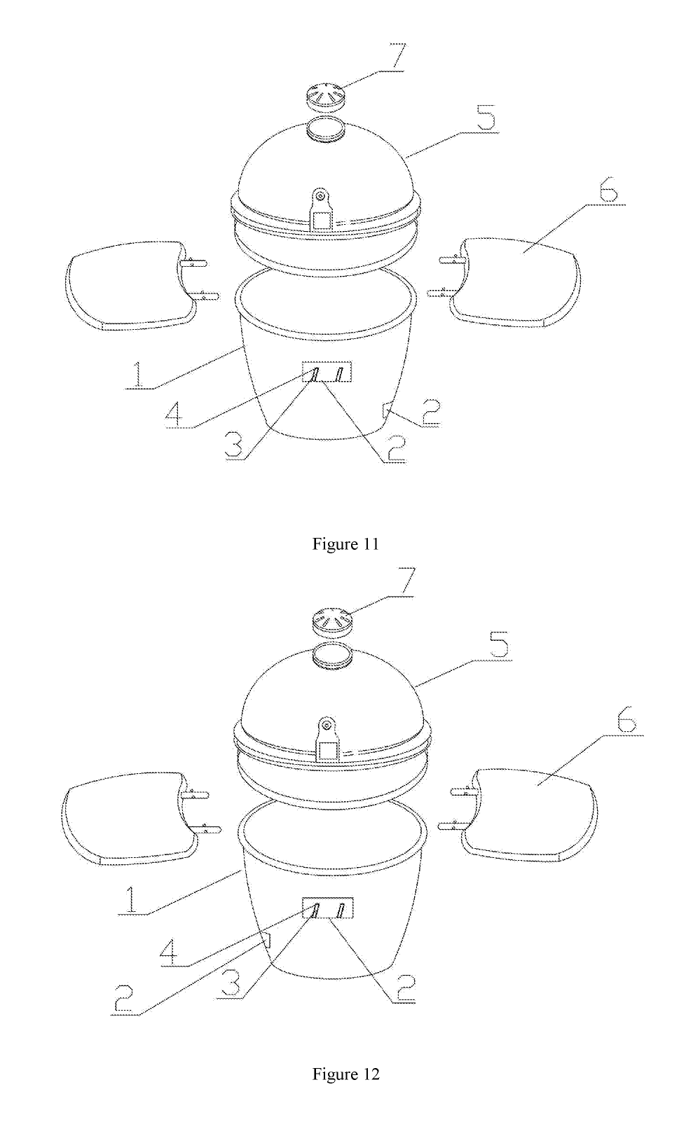

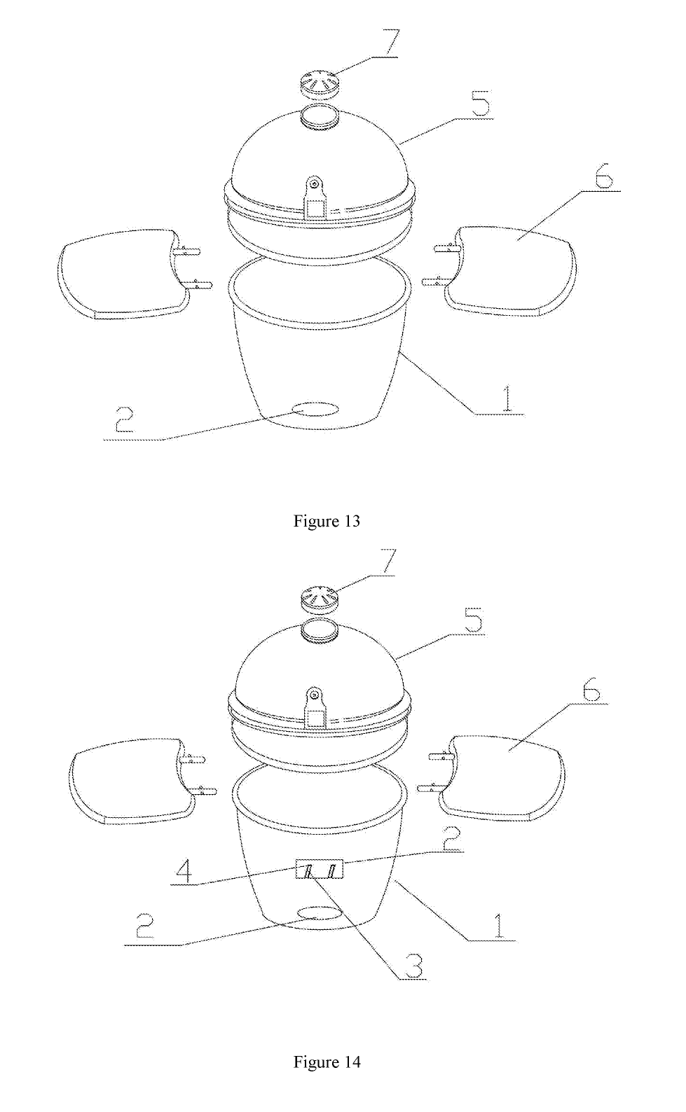

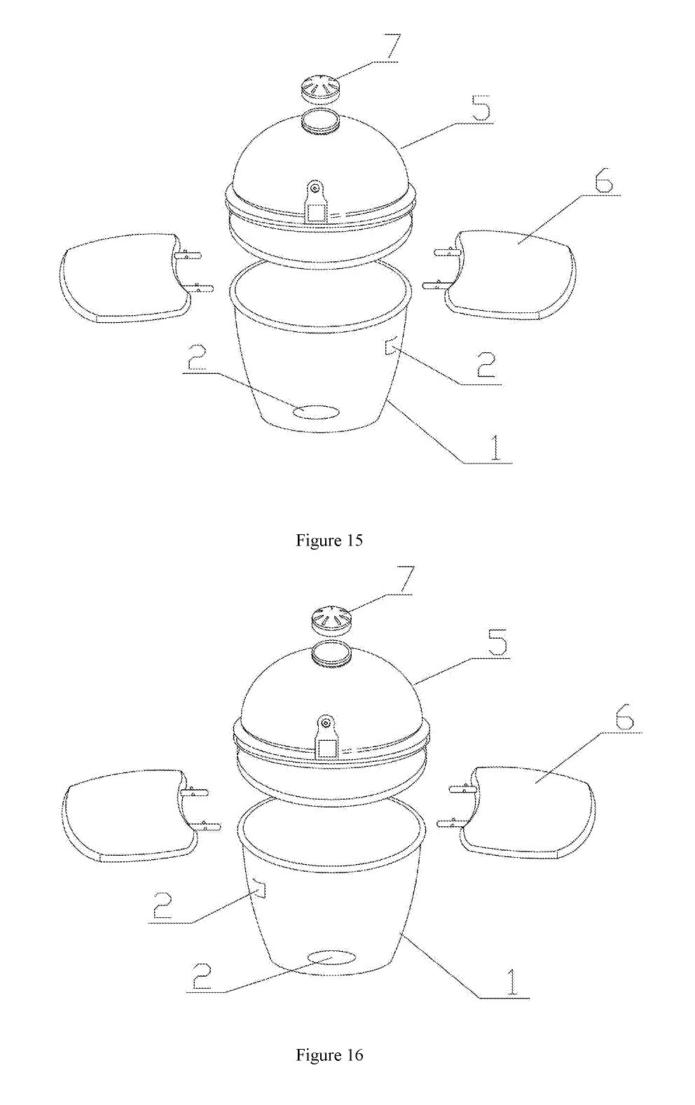

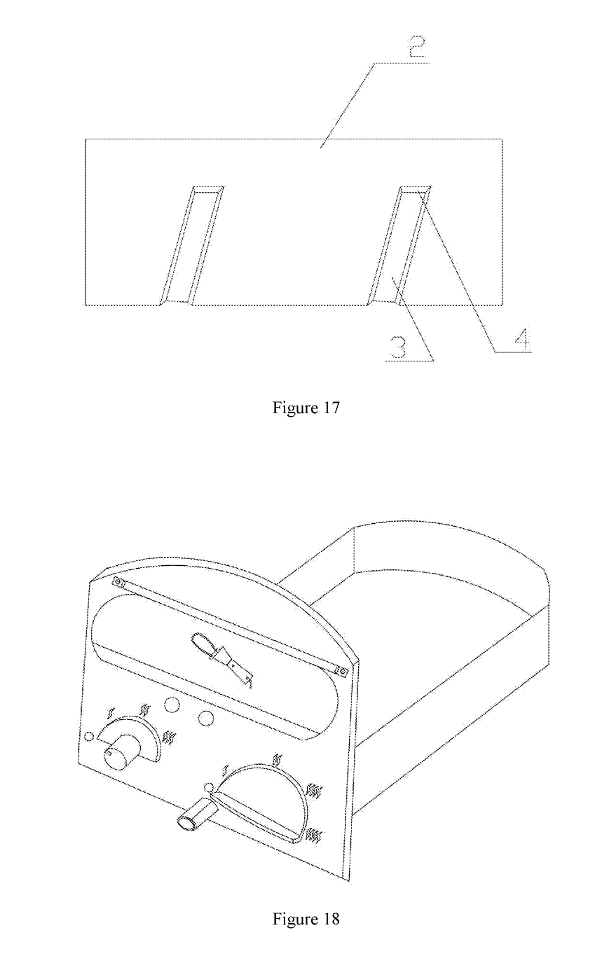

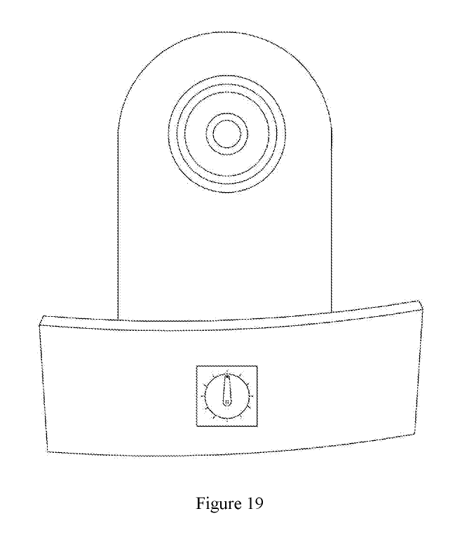

As shown in FIG. 1 to FIG. 19, the ceramic oven mainly comprises an oven body (1), a base and an Insert, wherein the oven body (1) is placed on the base, an oven cover (5) is arranged at the top of the oven body (1) and a cover cap (7) is arranged on the oven cover (5), placing tables (6) are installed on the left and right sides of the oven body (1) through bolts, more than one hole (2) is formed on the side wall or at the bottom of the oven body (1), a track (3) is paved in the hole (2), and a limiting baffle plate (4) is arranged at the top of the track (3); and the insert is inserted on the track (3) of the hole (2).

The ceramic oven and the installation method of the insert on the oven body thereof, wherein the method comprises the following steps: forming the hole for the oven body-paving the track-inserting the “Insert”-processing the “Insert”;

Step I, forming the hole for the oven body: after a ceramic oven body is molded, the hole (2) for inserting the “Insert” is preformed on the side wall of the body thereof, and size and shape of the hole are matched with the “Insert” to be inserted;

Step II, paving the track: the track (3) for facilitating access of the “Insert” is paved in the preformed hole (2) of the “Insert”, and a fixing device of the limiting baffle plate (4) and the “Insert” is arranged on the track (3);

Step III, inserting the “Insert”: an inserting end of the “Insert” is placed on the track (3) of the hole (2) of the “Insert”, and the “Insert” is pushed into the ceramic oven body;

Step IV, processing the “Insert”: when the “Insert” is a particle charcoal placing box or an ash pit box, the ash pit is taken out after being filled with charcoal ash, the charcoal ash is poured into a garbage can, and the “Insert” is inserted into the ceramic oven body; when the “Insert” is a gas box or an electromagnetic box, the insert is not often taken out; and when the “Insert” is a baking tray or a spice box, the insert is taken out after food in the baking tray is baked completely.

Further, the insert of the disclosure is the particle charcoal placing box or the gas box or the electromagnetic box or the ash pit box or the baking tray or the spice box.

Further, when the number of the hole (2) of the disclosure is one, the hole (2) is arranged on the front side wall or the rear side wall or the left side wall or the right side wall of the oven body (1) or at the bottom of the oven body (1); and when the number of the hole (2) is two, the hole (2) is arranged on the same side wall or different side walls of the oven body (1).

Further, the insert (the English name is Insert) in the disclosure is a functional box designed for the ceramic oven.

Further, originally, the insert in the disclosure is designed for removing the charcoal ash in the ceramic oven effectively and rapidly.

Further, the insert in the disclosure creates different function extensions according to a usage method, and can be divided into the following ones:

1) Particle box, also called Pellet Insert: the insert is used by the ceramic oven by transferring wood chips as fuel;

2) Gas box, also called Gas Insert: the insert is used by the ceramic oven by connecting liquefied petroleum gas as fuel;

3) Electromagnetic box, also called Electric Insert: the insert is used by the ceramic box with fuel of powering on;

4) Multi-function box, also called Multi-Insert: it can be used as the baking tray or the spice box.

5) Ash pit box, also called Ash Drawer: When charcoal fuel is used by the ceramic oven and the charcoal ash generated is fallen from the oven, the charcoal ash is caught by the ash pit box, and when the ash pit is filled with the charcoal ash, the ash pit is taken out to pour the charcoal ash into the garbage can.

Further, the disclosure is a combination or assembly way of the “oven body” and the “Insert” and a selectivity that the “Insert” is easy to replace.

The insert has the following assembly ways:

1. A single insert may be installed at either side of the ceramic oven body, such as: the front side, the rear side, the left side or the right side; and a height that the insert is installed at one side of the ceramic oven body is not limited.

2. When two inserts are simultaneously arranged on the ceramic oven body, one may be configured to catch the charcoal ash, and the other may be used as the baking tray or the spice box. The insert for catching the charcoal ash and the insert as the baking tray can be simultaneously arranged at one side of the ceramic oven body, and can also be arranged at different sides of the ceramic oven body.

3. Shapes, sizes and materials of the ceramic oven body and the insert are not limited, as long as the installation of the two is matched. Further, due to difference of the fuel used in the disclosure, the “Insert” with a use purpose of different fuels can be replaced at any time, thereby adding a diversified selection of the ceramic oven in the different fuels or different environments.

The embodiment has beneficial effects that:

The ceramic oven has characteristics of diversified energy use, good taste of baked food and convenient use.

The disclosure has described through the embodiments, but it should be understood that, the embodiments are only for illustrating and explaining, rather than limiting the disclosure in the described scope of the embodiment. In addition, those skilled in the art can understand that, the disclosure is not limited to the embodiments, and more variations and modifications can also be made according to an instruction of the disclosure, which are within the scope claimed by the disclosure. The protection scope of the disclosure is defined by attached claims and equivalent scope thereof.

1. A ceramic oven and an installation method of an insert on an oven body thereof, wherein the ceramic oven mainly comprises the oven body (1), a base and an insert, wherein the oven body (1) is placed on the base, an oven cover (5) is arranged at the top of the oven body (1) and a cover cap (7) is arranged on the oven cover (5), placing tables (6) are installed on the left and right sides of the oven body (1) through bolts, more than one hole (2) is formed on the side wall or at the bottom of the oven body (1), a track (3) is paved in the hole (2), and a limiting baffle plate (4) is arranged at the top of the track (3); and the insert is inserted on the track (3) of the hole (2).

2. The ceramic oven and the installation method of the insert on the oven body thereof according to claim 1, wherein the method comprises the following steps: forming the hole for the oven body-paving the track-inserting the “Insert”-processing the “Insert”.
Step I, forming the hole for the oven body: after a ceramic oven body is molded, the hole (2) for inserting the “Insert” is preformed on the side wall of the body thereof, and size and shape of the hole are matched with the “Insert” to be inserted;
Step II, paving the track: the track (3) for facilitating access of the “Insert” is paved in the preformed hole (2) of the “Insert”, and a fixing device of the limiting baffle plate (4) and the “Insert” is arranged on the track (3);
Step III, inserting the “Insert”: an inserting end of the “Insert” is placed on the track (3) of the hole (2) of the “Insert”, and the “Insert” is pushed into the ceramic oven body;
Step IV, processing the “Insert”: when the “Insert” is a particle charcoal placing box or an ash pit box, the ash pit is taken out after being filled with charcoal ash, the charcoal ash is poured into a garbage can, and the “Insert” is inserted into the ceramic oven body; when the “Insert” is a gas box or an electromagnetic box, the insert is not often taken out; and when the “Insert” is a baking tray or a spice box, the insert is taken out after food in the baking tray is baked completely.

3. The ceramic oven and the installation method of the insert on the oven body thereof according to claim 1, wherein the insert is the particle charcoal placing box or the gas box or the electromagnetic box or the ash pit box or the baking tray or the spice box.

4. The ceramic oven and the installation method of the insert on the oven body thereof according to claim 1, wherein when the number of the hole (2) is one, the hole (2) is arranged on the front side wall or the rear side wall or the left side wall or the right side wall of the oven body (1) or at the bottom of the oven body (1); and when the number of the hole (2) is two, the hole (2) is arranged on the same side wall or different side walls of the oven body (1).
